(19) United States
(12) Patent Application Publication
(10) Pub. No.: US 2017/0044806 A1
(43) Pub. Date: Feb. 16, 2017

(54) SWING BAR SECURITY LOCK

(71) Applicant: William A. Stansell, Port Orange, FL (US)

(72) Inventor: William A. Stansell, Port Orange, FL (US)

(21) Appl. No.: 15/003,136

(22) Filed: Jan. 21, 2016

Related U.S. Application Data
(60) Provisional application No. 62/203,589, filed on Aug. 11, 2015.

(51) Int. Cl. E05C 17/04; E05C 19/00; E05C 3/00

(52) U.S. Cl. CPC E05C 17/04; E05C 3/004; E05C 19/005

(57) ABSTRACT

A swing bar security lock includes an elongated, generally U-shaped main body having a first arm, a second arm and a curved middle section. The main body is constructed from a single piece of metal, and includes a dimension for receiving a swing bar guard that is in the locked position. A connector such as a locking pin is removably positioned within apertures that are disposed along the bottom portions of the first and second arms.

### CROSS-REFERENCE TO RELATED APPLICATIONS

This application claims the benefit of U.S. Application Ser. No. 62/203,589 filed on Aug. 11, 2015, the contents of which are incorporated herein by reference.

### TECHNICAL FIELD

The present invention relates generally to locking mechanisms, and more particularly to a security lock for maintaining a swing bar door guard in the closed and locked position.

### BACKGROUND

The statements in this section merely provide background information related to the present disclosure and may not constitute prior art.

Within the hotel industry, it is common to provide two distinct locking mechanisms on each room to provide safety and security to the room occupants. In this regard, most modern hotels utilize some type of electronic locking mechanism that works in conjunction with the users' room key, to allow the user to unlock the door from the outside. Unfortunately, these electronic locks are easily defeated by card skimmers and other such devices which can spoof the users' room key and allow the lock to disengage.

For this reason, hotels also provide a physical locking mechanism which can be selectively engaged by the user once they are inside of the room. To this end, background FIG. 1, illustrates a conventional swing bar guard 5 which is among the most commonly utilized locking mechanism found in hotel rooms. As shown, the guard typically consists of a fixed rod 5a having an enlarged end 5a1 that is mounted 5a2 onto the door 1. Likewise, a moveable slotted swing arm 5b which has an enlarged entrance 5b1 is mounted 5b2 onto the doorjamb. The enlarged entrance 5b1 being configured to receive the enlarged end 5a1, and the remaining slot is of a size which prevents the fixed rod end from being freed from the slotted arm. This arrangement permits the occupant of the room to open the door but a few inches to greet anyone outside of the door, but prevents entry of that person into the room. The fixed rod cannot be removed from the slotted arm without closing the door because of the location of the enlarged entry in the slot.

Although swing bar guards are useful for defeating unsophisticated thieves, robbers and other unsavory individuals, there are several known methods and devices that are designed specifically to allow such mechanisms to be opened by a user who is not within the room. One such example includes U.S. Pat. No. 5,937,713, to Walters, the contents of which are incorporated herein by reference. Although the Walters patent is designed to aid the hotel industry in gaining access to a vacant room wherein the swing bar has accidentally engaged, the fact remains that such products can be utilized by ne'er-do-wells for illegal purposes, thereby exposing the room occupants to crime.

Rather than requiring the entire hotel industry to replace the millions of existing swing bar mechanisms, it would be beneficial to provide a low cost security lock which can be fitted over the fixed rod and the slotted arm of an existing swing bar, to ensure that the mechanism cannot be unlocked from the outside of the room.

### SUMMARY OF THE INVENTION

The present invention is directed to a swing bar security lock. One embodiment of the present invention can include an elongated, generally U-shaped main body having a first arm, a second arm and a curved middle section. The main body is preferably constructed from a single piece of metal, such as steel, and can be placed over a swing bar guard that is in the locked position. A connector can be positioned between the first and second arms at a location beneath the installed swing bar guard, and can prevent the lock from being dislodged.

In another embodiment, the main body can be partially or entirely coated with a non-skid material such as rubber, for example, to prevent movement of the lock on the swing bar guard. In yet another embodiment, the removable connector can include a locking pin that is positioned within apertures that are disposed along the bottom portions of the first and second arms.

This summary is provided merely to introduce certain concepts and not to identify key or essential features of the claimed subject matter.

### BRIEF DESCRIPTION OF THE DRAWINGS

Presently preferred embodiments are shown in the drawings. It should be appreciated, however, that the invention is not limited to the precise arrangements and instrumentalities shown.

FIG. 1 is a front view of a swing bar guard, in accordance with the background art.

FIG. 2 is a perspective view of the swing bar security lock, in accordance with one embodiment of the invention.

FIG. 3A is a side view of the swing bar security lock, in accordance with one embodiment of the invention.

FIG. 3B is a side view of the swing bar security lock, in accordance with another embodiment of the invention.

FIG. 4 is a perspective view of the swing bar security lock in operation, in accordance with one embodiment of the invention.

FIG. 5 is another perspective view of the swing bar security lock in operation, in accordance with one embodiment of the invention.

FIG. 6 is yet another perspective view of the swing bar security lock in operation, in accordance with one embodiment of the invention.

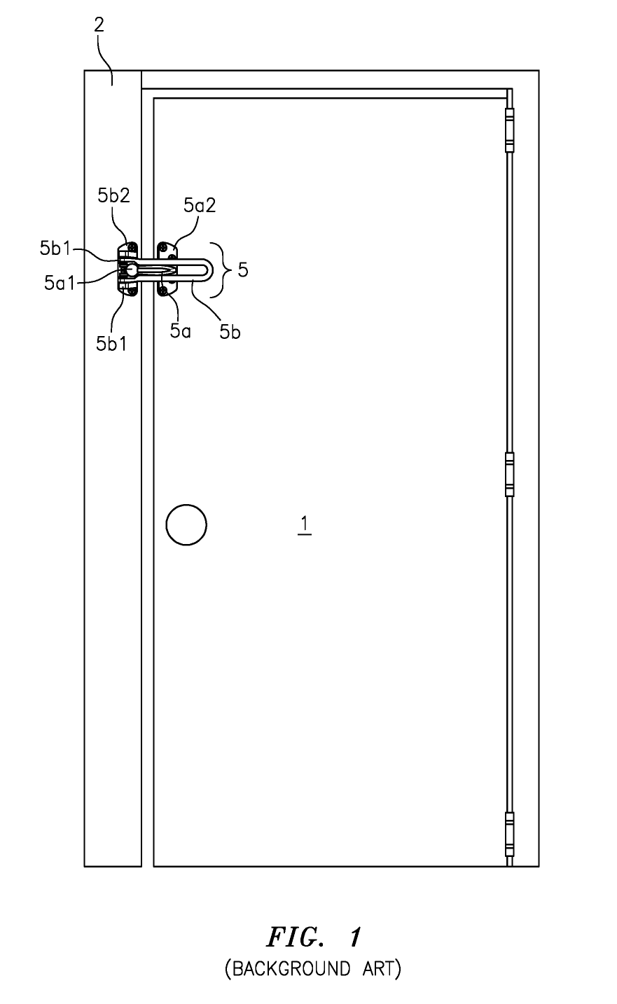

### DETAILED DESCRIPTION OF THE INVENTION

While the specification concludes with claims defining the features of the invention that are regarded as novel, it is believed that the invention will be better understood from a consideration of the description in conjunction with the drawings. As required, detailed embodiments of the present invention are disclosed herein; however, it is to be understood that the disclosed embodiments are merely exemplary of the invention which can be embodied in various forms. Therefore, specific structural and functional details disclosed herein are not to be interpreted as limiting, but merely as a basis for the claims and as a representative basis for teaching one skilled in the art to variously employ the inventive arrangements in virtually any appropriately detailed structure. Further, the terms and phrases used herein are not intended to be limiting but rather to provide an understandable description of the invention.

As described herein, the term “removably secured,” and derivatives thereof shall be used to describe a situation wherein two or more objects are joined together in a non-permanent manner so as to allow the same objects to be repeatedly joined and separated.

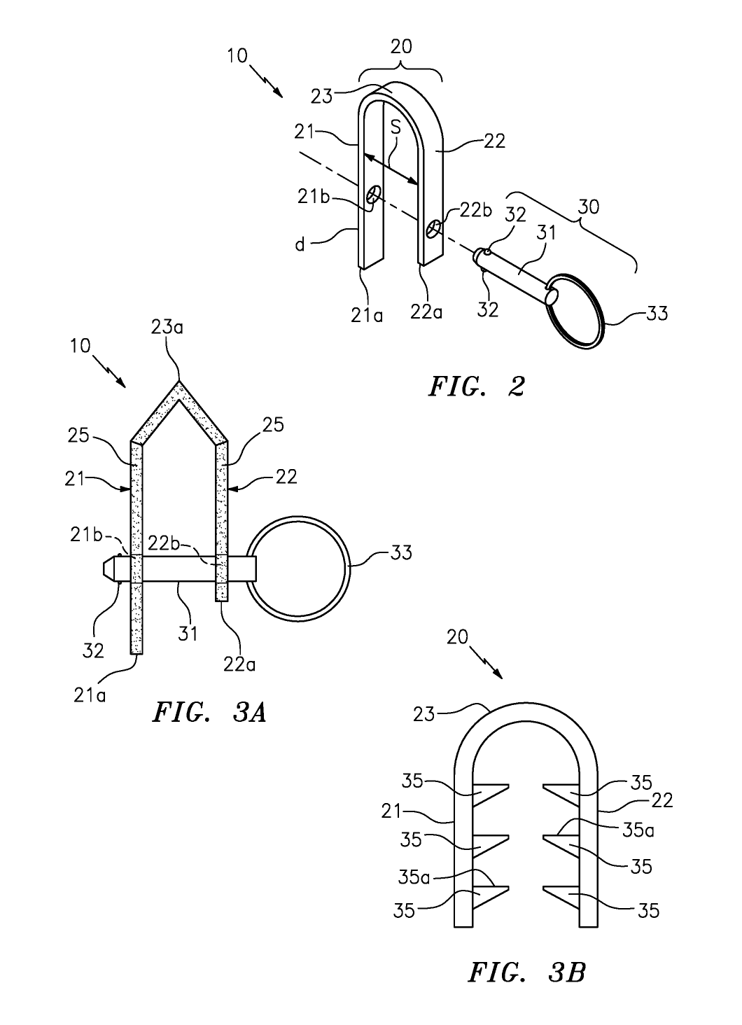

Identical reference numerals are used for like elements of the invention or elements of like function. For the sake of clarity, only those reference numerals are shown in the individual figures which are necessary for the description of the respective figure. For purposes of this description, the terms “upper,” “bottom,” “right,” “left,” “front,” “vertical,” “horizontal,” and derivatives thereof shall relate to the invention as oriented in FIG. 2.

FIG. 2 illustrates one embodiment of a swing bar security lock 10 that is useful for understanding the inventive concepts disclosed herein. As shown, the device 10 can include a main body 20 and a removable connector 30.

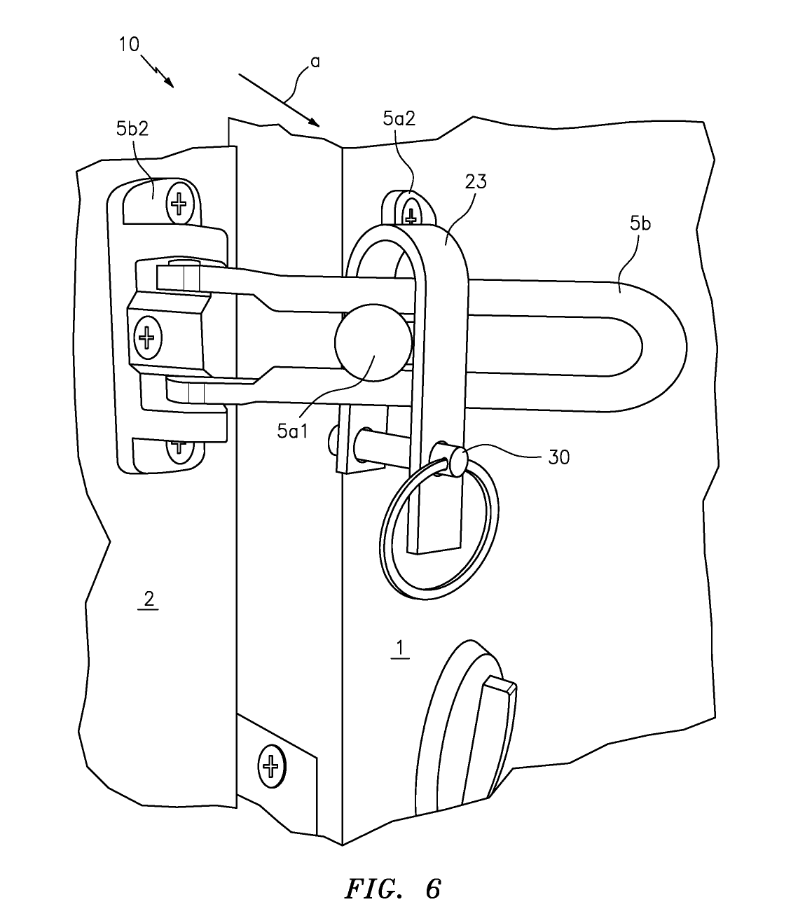

In the illustrated embodiment, the main body 20 can include two generally parallel arms 21 and 22 that are joined via a curved middle section 23, to form an elongated U-shape. As shown, the first arm 21 is preferably longer than the second arm 22, and is intended to be positioned between the mount and the door, so as to provide increased surface contact with the swing arm mount 5b2 should someone attempt to open the guard 5 when the lock is attached (see FIG. 5).

The main body 20 can preferably be constructed from a single piece of metal such as steel, for example, that is bent to form the illustrated shape; however, other shapes, materials and/or construction methodologies are also contemplated. As such, other embodiments are also contemplated wherein the first and second arms include identical lengths, and/or the arms are not parallel with one another.

In either instance, the first and second arms can further include apertures 21b and 22b, respectively, that are aligned to receive the below described connector 30. In the preferred embodiment, aperture 22b can be located adjacent to the distal end 22a, and aperture 21b can be positioned a first distance d from the distal end 21a. Of course, the apertures can be located anywhere along the main body so as to allow the connector 30 to be positioned beneath the swing guard 5, so as to allow the device to completely encircle a portion of the swing guard.

Although other dimensions are contemplated, in the preferred embodiment, the first arm 21 can include a length (e.g., distance between middle section 23 and distal end 21a) of approximately 2.5 inches, the second arm 22 can include a length (e.g., distance between middle section 23 and distal end 22a) of approximately 1.75 inches, and the first distance d can be approximately 0.5 inches. Moreover, the curved middle section 23 can position the first and second arms in a parallel orientation with a separation distance S of approximately 0.75 inches. Such dimensions being suitable for and/or necessary to allow the fixed rod 5a and the slotted swing arm 5b of a commercially available swing bar door guard 5 to be positioned between the arms 21 and 22, and secured in place via the locking pin, as shown below.

As described herein, the connector 30 can include any device or component capable of being removably secured to each of the first and second arms 21 and 22, respectively, so as to create a lower barrier for encircling a swing bar guard that is positioned between the first and second arms. Several nonlimiting examples of suitable connectors include tethers, cables, clamps and other such devices.

In the preferred embodiment, the connector can comprise a locking pin that includes an elongated steel shaft 31 having a shape and dimension that is suitable for being positioned within the apertures 21b and 22b, respectively. The locking pin can include one or more nubs/protrusions 32 along a first end, and a pull tab 33 along a second end. Locking pins are extremely well known in the art, therefore a further description is not provided.

As shown best in FIG. 3A, the main body can also include a non-skid coating 25 incorporating a material such as rubber, for example, that has a high coefficient of friction when placed against metal. The coating 25 can be disposed along a portion or an entirety of the main body 20 and can prevent the device 10 from scraping the door 1 and/or door guard 5 to which it is installed. Such a feature can also prevent the main body 20 from sliding up and off of the door guard when a pulling or shaking motion is imparted on the slotted swing arm 5b (see FIG. 5 below).

As is also shown in FIG. 3A, in various embodiments the curved middle section 23 can include a pointed shape, having apex 23a that is positioned equidistantly between the first and second arms 21 and 22, respectively. Such a feature can utilize the force of gravity to maintain the guard 5 within the apex of the curve, and to ensure the device 10 remains in the illustrated upright position.

FIG. 3B illustrates another embodiment of the device that further includes a plurality of generally malleable shelves 35 and/or bristles, for example, that radiate inward from each of the first and second arms 21 and 22. The shelves can preferably be constructed from a resilient material such as rubber, for example, so as to be able to bend and return to the illustrated shape. Each of the shelves can preferably include a generally planar top surface, and can make contact with the bottom surface of a door guard 5 that is positioned between the first and second arms. The shelves 35 can function to ensure the main body does not become easily dislodged from the door guard in instances where the connector 30 is not being utilized.

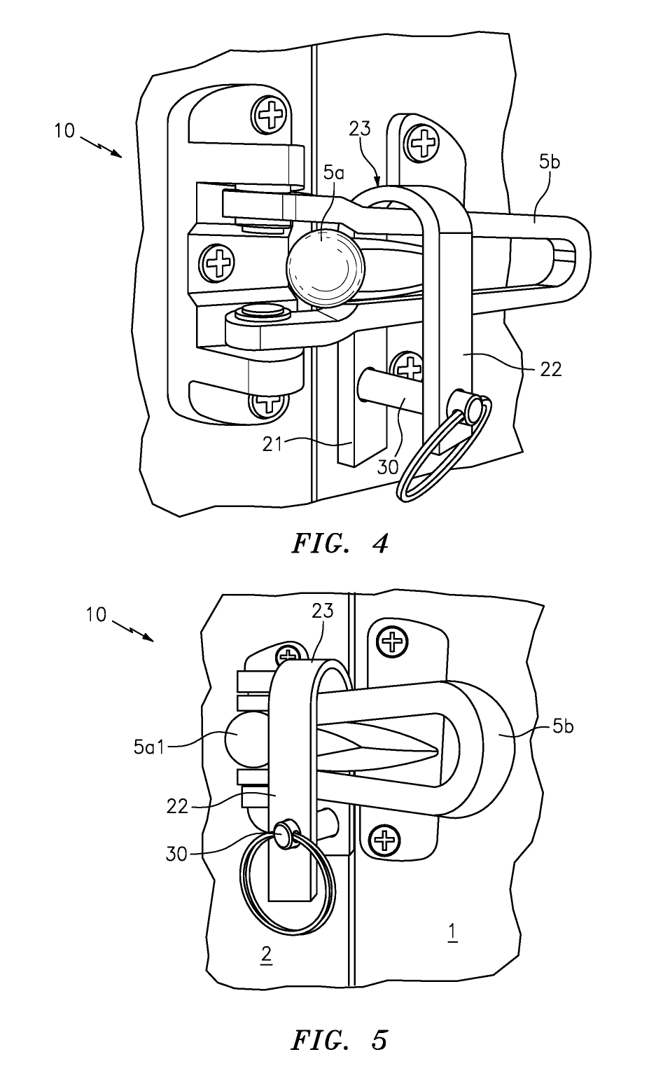

FIGS. 4-6 illustrate one embodiment of the device 10 in operation. As shown, in FIG. 4, the main body 20 can be positioned over an existing door guard 5 that is in the locked position (i.e., the fixed rod 5a is positioned within the slotted swing arm 5b). When so located, the curved middle section 23 can be in contact with the top of the door guard, and the arms 21 and 22 can be positioned behind and in front of the door guard, respectively. Although the main body can be utilized without the removable connector, it is preferred that the locking pin or other such connector 30 always be utilized for the reasons described below. In this regard, the locking pin can be secured within the apertures 21b and 22b, respectively via a pushing motion.

As shown in FIGS. 5 and 6, once installed onto the door guard 5, any attempts to open the door will result in the device 10 locking the swing arm 5b and the fixed rod 5a together. Moreover, the presence of the device also prevents the door from opening to the full extent that would otherwise be allowable by the door guard 5, as the device 10 will engage the enlarged end Sal of the fixed rod (see FIG. 6).

Moreover, owing to the nonslip coating, and the removable connector 30, any attempts to rattle or shake the swing arm will not dislodge the lock from the guard. Finally, by utilizing the locking pin as the connector, such a device must be pulled toward the inside of the room with a sufficient force to be removed from the main body 20. As such, any attempts at removing the pin utilizing the thin, lightweight devices described in the above referenced Walters patent, for example, will not be successful, as such devices are designed to be relatively malleable in nature.

Accordingly, the swing bar security lock 10 provides a novel solution for ensuring a safe environment within rooms and buildings that utilize conventional swing bar guards. Moreover, although described and illustrated for use with a swing guard mechanism 5 and a hotel setting, the inventive concepts disclosed herein are not to be construed as limiting to any particular type of mechanism or environment. To this end, the above described security lock 10 can be utilized in conjunction with any type of door mounted mechanism, in order to prevent the same from being opened from the outside.

As described herein, one or more elements of the swing bar security lock 10 can be secured together utilizing any number of known attachment means such as, for example, screws, glue, compression fittings and welds, among others. Moreover, although the above embodiments have been described as including separate individual elements, the inventive concepts disclosed herein are not so limiting. To this end, one of skill in the art will recognize that one or more individual elements may be formed together as one continuous element, either through manufacturing processes, such as welding, casting, or molding, or through the use of a singular piece of material milled or machined with the aforementioned components forming identifiable sections thereof.

As to a further description of the manner and use of the present invention, the same should be apparent from the above description. Accordingly, no further discussion relating to the manner of usage and operation will be provided.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A lock device for a swing bar guard having a fixed rod and a moveable slotted swing arm, said lock device comprising:
a main body that includes a first arm, a second arm, and a curved middle section forming an elongated U-shape;
each of the first arm, second arm, and middle section including dimensions that are suitable for receiving the swing bar guard therebetween.

2. The lock device of claim 1, further comprising:
a non-skid coating that is disposed along a portion of the main body, and includes a high coefficient of friction when placed in contact with metal.

3. The lock device of claim 1, further comprising:
a connector that is removably secured along a bottom portion of each of the first arm and the second arm.

4. The lock device of claim 1, further comprising:
a first aperture disposed within the first arm;
a second aperture disposed within the second arm; and
a connector that includes a locking pin that is removably positioned within the first and second apertures.

5. The lock device of claim 4, wherein the locking pin comprises:
an elongated steel shaft having a shape and dimension suitable for engaging the first and second apertures;
one or more nubs located along a first end of the steel shaft; and
a pull tab that is located along a second end of the steel shaft.

6. The lock device of claim 1, wherein the first arm includes a length that is greater than a length of the second arm.

7. The lock device of claim 1, wherein the main body is constructed from single piece of steel.
